(19) United States
(12) Patent Application Publication
(10) Pub. No.: US 2021/0313078 A1
(43) Pub. Date: Oct. 7, 2021

(54) FOG-BASED DECENTRALIZED INFRASTRUCTURE FOR FIRMWARE SECURITY INTEGRITY CHECKING TO ENHANCE PHYSICAL, OPERATIONAL AND FUNCTIONAL SECURITY OF IOT SYSTEMS

(71) Applicant: ASPISEC S.r.I., Rome (IT)

(72) Inventors: Andrea Chiappetta, Rome (IT); Andrea Battaglia, Rome (IT)

(21) Appl. No.: 16/840,296

(22) Filed: Apr. 3, 2020

(51) Int. Cl. G16Y 30/10; G16Y 20/20; G16Y 40/50; G16Y 40/10; G06F 21/57; G06F 9/54

(52) U.S. Cl. CPC G16Y 30/10; G16Y 20/20; G06F 9/542; G16Y 40/10; G06F 21/572; G16Y 40/50

(57) ABSTRACT

Embodiments of the present invention provide a novel and non-obvious method, system and computer program product for securing the firmware of an IoT instrumented device. In an embodiment of the invention, a method for securing an IoT instrumented device includes detecting a change in the installed firmware reflective of a replacement of the installed firmware with replacement firmware. The method additionally includes comparing differences in programmatic directives between two different firmware versions: a previous release of a current running firmware and new different firmware release. Finally, the method includes transmitting an alert message to an operator upon detecting a threshold difference in at least one of the programmatic directives.

### BACKGROUND OF THE INVENTION

### Field of the Invention

The present invention relates to the field of Internet of Things (IoT) and more particularly to the securing of IoT devices.

### Description of the Related Art

IoT refers to a vast web of connected devices over the global Internet by way of the instrumentation of ordinary machines ranging from toasters to automobiles. Literally, anything that can be powered on or off, once instrumented for IoT permits one-way or two-way interactions over the Internet. These interactions can range from merely reporting a status of a sensor, for instance an ordinary value, to receiving directives effectively remotely operating an IoT enabled device. While the advantages of IoT enabling a machine are substantial, those advantages come at a cost—the creation of a security vulnerability in the machine.

In this regard, as a stand-alone unit, a stand-alone device or machine including a sensor is impervious to remote threats by and large. But, just like any other connected personal computer, a device or machine configured for IoT becomes vulnerable to remote threats including network intrusions. In this regard, like other devices, an IoT device is able to detect and deter a breach of its integrity by monitoring the introduction of code in the memory of the IoT device in order to detect malicious code. But, the program logic able to do generally in included as part of the underlying operating system, or as part of a computer program executing under management by the operating system. Consequently, malicious code surreptitiously inserted into the IoT device at the pre-operating system level—namely the firmware—can avoid detection by operating system or post-operating system level countermeasures.

### BRIEF SUMMARY OF THE INVENTION

Embodiments of the present invention address deficiencies of the art in respect to securing IoT devices and provide a novel and non-obvious method, system and computer program product for securing the firmware of an IoT instrumented device. In an embodiment of the invention, a method for securing an IoT instrumented device includes detecting a change in the installed firmware reflective of a replacement of the installed firmware with replacement firmware. The method additionally includes comparing differences in programmatic directives between two different firmware versions: a previous release of a current running firmware and new different firmware release. Finally, the method includes transmitting an alert message to an operator upon detecting a threshold difference in at least one of the programmatic directives.

In one aspect of the embodiment, the programmatic directives include a count of a pre-defined function in two different firmware versions. In another aspect of the embodiment, the programmatic directives include a jump address in the current firmware and a corresponding jump address in the replacement firmware. In yet another aspect of the embodiment, the programmatic directives include a number of input/output requests in the current firmware and in the replacement firmware. Finally, it is of note that the current firmware may include a multiplicity of files defining the installed firmware such that the comparison is a comparison of the programmatic directives in a set of the files defining the installed firmware and in a set of files defining the replacement firmware.

In another embodiment of the invention, an IoT instrumented device may be configured for firmware security assurance. The device includes a host computer with memory and at least one processor, and optionally included as part of the IoT instrumented device. The device also includes a firmware security module executing by the at least one processor and communicatively coupled to firmware within an IoT instrumented device. In this regard, the module includes computer program instructions able to detect a change in the installed firmware reflective of a replacement of the installed firmware with replacement firmware, compare differences in programmatic directives between two different firmware versions and transmit an alert message to an operator upon detecting a threshold difference in at least one of the programmatic directives.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for securing an IoT instrumented device;

FIG. 2 is a schematic illustration of a data processing system configured for securing an IoT instrumented device; and,

FIG. 3 is a flow chart illustrating a process for securing an IoT instrumented device.

### DETAILED DESCRIPTION OF THE INVENTION

Embodiments of the invention provide for the securing of an IoT instrumented device. In accordance with an embodiment of the invention, changes to firmware disposed within the IoT instrumented device are monitored. Upon determining that the existing firmware of the device has been replaced with replacement firmware, the program code of the replacement firmware is compared to the program code of the existing firmware. To the extent that a characteristic of one or more of the programmatic directives of the firmware have changed as between the existing firmware and the replacement firmware, such as a count of a pre-defined function present in the firmware, a jump address included as part of a jump operation present in the firmware, or a number of input/output requests within the firmware, an alert is transmitted to an operator indicating a potential threat posed by the replacement firmware.

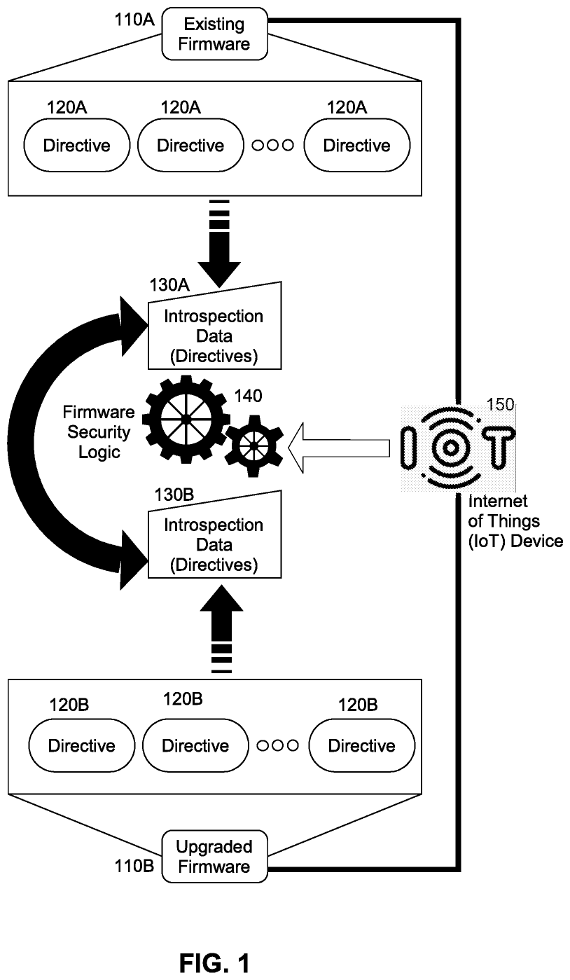

In further illustration, FIG. 1 pictorially shows a process for securing an IoT instrumented device. As shown in FIG. 1, firmware security logic 140 monitors an IoT device 150 for an upgrading of existing firmware 110A with upgraded firmware 110B. The existing firmware 110A includes a set of programmatic directives 120A, including program instructions invoking processor operations and referencing memory addresses in memory of the IoT device 150. The firmware security logic 140 characterizes the directives 120A into introspection data 130A, for example according to a distribution of a number of instances of different types of the directives 120A, a particular memory address referenced by a corresponding one or more of the directives 120A, or an input/output address referenced by a corresponding one or more of the directives 120A.

Thereafter, the firmware security logic 140 processes the upgraded firmware 110 in order to identify the directives 120B included as part of the upgraded firmware 110. As part of the processing of the upgraded firmware 110, the firmware security logic 140 characterizes the directives 120B into introspection data 130B, for example according to a distribution of a number of instances of different types of the directives 120B, a particular memory address referenced by a corresponding one or more of the directives 120B, or an input/output address referenced by a corresponding one or more of the directives 120B. Once the characterization of the directives 120B has been achieved so as to produce the introspection data 130B, the firmware security logic 140 compares the introspection data 120B to the introspection data 130A in order to determine any threshold differences.

In this regard, the threshold differences between the introspection data 130A and the introspection data 130B may include a different jump address referenced by a corresponding one of the directives 120A in the existing firmware 110A than a jump address of corresponding one of the directives 120B in the upgraded firmware 110B. As another possibility, the threshold differences between the introspection data 130A and the introspection data 130B may include a different number of a particular type of the directives 120A in the existing firmware 110A as compared to the same type of the directives 120B in the upgraded firmware 110B. As yet another possibility, the threshold differences between the introspection data 130A and the introspection data 130B may include a change in an I/O address referenced by one of the directives 120B in the upgraded firmware 110B from a corresponding one of the directives 120A in the existing firmware 110A.

Upon detecting a threshold difference between the introspection data 130A and the introspection data 130B, the firmware security logic 140 blocks the replacement of the existing firmware 110A with the upgraded firmware 110B and transmits a message to an operator. For instance, the message may be an alert provided as a text message to mobile device mail registered with the firmware security logic 140, or an e-mail message to an e-mail address registered with the firmware security logic 140. Optionally, a signal may be received in the firmware security logic 140 from the operator overriding the blocking of the replacement of the existing firmware 110A with the upgraded firmware 110B, so that subsequent to the replacement of the existing firmware 110 with the upgraded firmware 110B, the upgraded firmware 110B becomes the existing firmware 110A and the introspection data 130B becomes the introspection data 130A.

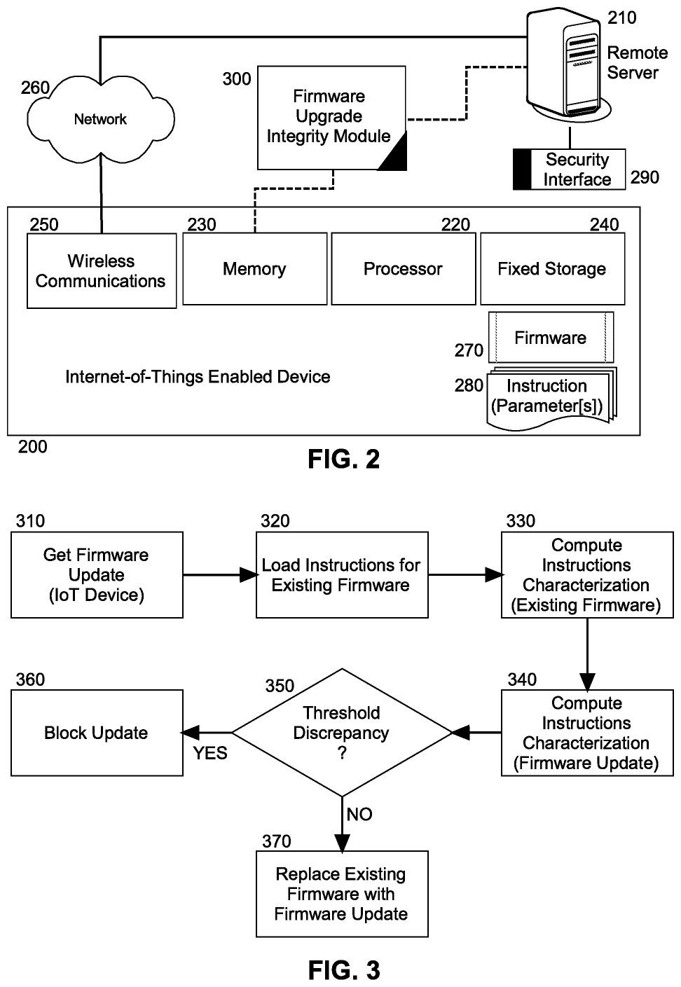

The process described in connection with FIG. 1 may be implemented within a data processing system. In further illustration, FIG. 2 schematically shows a data processing system configured for securing an IoT instrumented device. The system includes an IoT enabled device 200 that includes at least one processor 220, memory 230, fixed storage such as non-volatile memory, and wireless communications circuitry 250 enabling wireless data communications with a remote server 210 over computer communications network 260. The fixed storage 240 includes firmware 270 having one or more programmatic instructions 280, each with a corresponding zero of more parameters, that executes prior to the loading of an operating system for the IoT enabled device 200.

The system also includes a firmware upgrade integrity module 300. As can be seen, the module 300 may be persisted in the memory 230 of the IoT enabled device, or the module 300 may be persisted in the memory (not shown) of the remote server 210. The module 300 includes computer program instructions that, during execution, characterize the instructions 280 and corresponding parameters of the firmware 270 and compare the characterization to a characterization of program instructions of a firmware update designated for replacing the firmware 270. The program instructions further transmit a message through the computer communications network 260 to security interface 290 of the remote server 210 indicating a threshold difference between the characterizations when such threshold difference exists and blocks replacement of the firmware 270 with the firmware update absent an override signal received from the security interface 290 over the computer communications network 260 in the IoT enabled device 200.

In even further illustration of the operation of the firmware upgrade integrity module 300, FIG. 3 is a flow chart illustrating a process for securing an IoT instrumented device. Beginning in block 310, a firmware update is received for installation in the IoT device as a replacement to existing firmware. In block 320, the programmatic directives of the existing firmware are loaded into memory and processed so as to compute a characterization of the existing firmware in block 330. The characterization includes, for example, a distribution of a number of instances of different types of the directives, a particular memory address referenced by a corresponding one or more of the directives, or an input/output address referenced by a corresponding one or more of the directives.

Concurrently, in block 340, the programmatic directives of the firmware upgrade are loaded into memory and processed so as to compute a characterization of the firmware upgrade. As before, the characterization includes, for example, a distribution of a number of instances of different types of the directives, a particular memory address referenced by a corresponding one or more of the directives, or an input/output address referenced by a corresponding one or more of the directives. Then, in decision block 350, it is determined if a threshold discrepancy exists between the characterization of the existing firmware and the characterization of the firmware upgrade. If the threshold discrepancy exists, in block 360, the firmware update is blocked from replacing the existing firmware. But if no threshold discrepancy exists, in block 370, the existing firmware is replaced with the firmware update.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for securing an Internet-of-Things (IoT) instrumented device comprising:
detecting a change in the installed firmware reflective of a replacement of the installed firmware with replacement firmware;
comparing differences in programmatic directives between the current firmware and in the replacement firmware; and,
transmitting an alert message to an operator upon detecting a threshold difference in at least one of the programmatic directives.

2. The method of claim 1, wherein the programmatic directives include a count of a pre-defined function in the current firmware and in the replacement firmware.

3. The method of claim 1, wherein the programmatic directives include a jump address in the current firmware and a corresponding jump address in the replacement firmware.

4. The method of claim 1, wherein the programmatic directives include a number of input/output requests in the current firmware and in the replacement firmware.

5. The method of claim 1, wherein the snapshot includes a multiplicity of files defining the installed firmware and the comparison is a comparison of the programmatic directives in a set of the files defining the installed firmware and in a set of files defining the replacement firmware.

6. An Internet-of-Things (IoT) instrumented device configured for firmware security assurance, the device comprising:
a host computer with memory and at least one processor;
a firmware security module executing by the at least one processor and communicatively coupled to firmware within an IoT instrumented device, the module comprising computer program instructions enabled during execution to perform:
detecting a change in the installed firmware reflective of a replacement of the installed firmware with replacement firmware;
comparing differences in programmatic directives between the current firmware and in the replacement firmware; and,
transmitting an alert message to an operator upon detecting a threshold difference in at least one of the programmatic directives.

7. The system of claim 6, wherein the programmatic directives include a count of a pre-defined function in the current firmware and in the replacement firmware.

8. The system of claim 6, wherein the programmatic directives include a jump address in the current firmware and a corresponding jump address in the replacement firmware.

9. The system of claim 6, wherein the programmatic directives include a number of input/output requests in the current firmware and in the replacement firmware.

10. The system of claim 6, wherein the snapshot includes a multiplicity of files defining the installed firmware and the comparison is a comparison of the programmatic directives in a set of the files defining the installed firmware and in a set of files defining the replacement firmware.

11. The system of claim 6, wherein the host computing platform is included as part of the IoT instrumented device.

12. A computer program product for securing an Internet-of-Things (IoT) instrumented device, the computer program product including a computer readable storage medium having program instructions embodied therewith, the program instructions executable by a device to cause the device to perform a method including:
detecting a change in the installed firmware reflective of a replacement of the installed firmware with replacement firmware;
comparing differences in programmatic directives between the current firmware and in the replacement firmware; and,
transmitting an alert message to an operator upon detecting a threshold difference in at least one of the programmatic directives.

13. The computer program product of claim 12, wherein the programmatic directives include a count of a pre-defined function in the current firmware and in the replacement firmware.

14. The computer program product of claim 12, wherein the programmatic directives include a jump address in the current firmware and a corresponding jump address in the replacement firmware.

15. The computer program product of claim 12, wherein the programmatic directives include a number of input/output requests in the current firmware and in the replacement firmware.

16. The computer program product of claim 12, wherein the snapshot includes a multiplicity of files defining the installed firmware and the comparison is a comparison of the programmatic directives in a set of the files defining the installed firmware and in a set of files defining the replacement firmware.
